(19) United States
(12) Patent Application Publication
(10) Pub. No.: US 2025/0332745 A1
(43) Pub. Date: Oct. 30, 2025

(54) ROBOTIC MANIPULATOR

(71) Applicant: Lunar Outpost Inc., Golden, CO (US)

(72) Inventors: Andrew Josef Gemer, Lafayette, CO (US); Justin Cyrus, Golden, CO (US); Van Wagner, Lakewood, CO (US); Grant Kahl, Golden, CO (US)

(21) Appl. No.: 19/189,850

(22) Filed: Apr. 25, 2025

Related U.S. Application Data
(60) Provisional application No. 63/639,537, filed on Apr. 26, 2024.
(60) Provisional application No. 63/639,542, filed on Apr. 26, 2024.

(51) Int. Cl. B25J 18/04; B25J 9/00; B25J 9/10; B25J 17/00; B25J 19/02

(52) U.S. Cl. CPC B25J 18/04; B25J 9/0021; B25J 9/102; B25J 17/00; B25J 19/02

(57) ABSTRACT

Aspects of the present disclosure relate to a ground-based vehicle with a single- or multi-degree-of-freedom robotic manipulator (“arm”), which may be attached to the a ground-based vehicle or to a stationary platform, among other examples. In examples, the purpose of the vehicle and arm assembly is to interact with a natural or man-made feature in some way; examples are include, but are not limited to, collecting a natural sample or specimen; unloading or repositioning the vehicle (e.g., from a lander, righting the vehicle after tipping, or raising/lowering the vehicle relative to terrain or man-made structures, etc.), collecting man-made items from the ground; grasping and actuating a man-made interface (such as a handle, cable, connector, hatch, door, etc.); servicing the vehicle; or assembling or constructing a structure from natural or man-made components (rocks, soil, beams, blocks, etc.), among other examples.

### CROSS-REFERENCE TO RELATED APPLICATION

This application claims priority to U.S. Provisional Application No. 63/639,537, titled “Multi-Articulated Ground Vehicle with Robotic Actuator and Manipulator and Associated Control Schema,” filed on Apr. 26, 2024, and U.S. Provisional Application No. 63/639,542, titled “Multi-Articulated Ground Vehicle with Active Attitude and Height Control,” filed on Apr. 26, 2024, the entire disclosures of which are hereby incorporated by reference in their entirety.

### BACKGROUND

Manipulation of a natural or man-made item may be necessary in instances where human involvement is limited or impossible. However, it may be challenging to perform these operations quickly and effectively while also maintaining positional accuracy and achieving fine-grained motion control. Additionally, certain environments may be challenging, for example with respect to temperature fluctuations and the potential for debris ingress, as, for example, may be present on the lunar surface.

It is with respect to these and other general considerations that embodiments have been described. Also, although relatively specific problems have been discussed, it should be understood that the embodiments should not be limited to solving the specific problems identified in the background.

### SUMMARY

Aspects of the present disclosure relate to a single- or multi-degree-of-freedom robotic manipulator (“arm”), which may be attached to a ground-based vehicle or to a stationary platform, among other examples. In examples, the purpose of the vehicle and arm assembly is to interact with a natural or man-made feature in some way; examples include, but are not limited to, collecting a natural sample or specimen; unloading or repositioning the vehicle (e.g., from a lander, righting the vehicle after tipping, or raising/lowering the vehicle relative to terrain or man-made structures, etc.), collecting man-made items from the ground; grasping and actuating a man-made interface (such as a handle, cable, connector, hatch, door, etc.); servicing the vehicle; or assembling or constructing a structure from natural or man-made components (rocks, soil, beams, blocks, etc.), among other examples.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

Non-limiting and non-exhaustive examples are described with reference to the following Figures.

FIG. 1 illustrates an overview of an example conceptual diagram of a system comprising a robotic arm according to aspects of the present disclosure.

FIGS. 2A-2C illustrate example robotic arm configurations that each have different associated degrees of freedom according to aspects described herein.

FIGS. 2D and 2E illustrate perspective views of an example robotic arm according to the configuration of the robotic arm depicted in FIG. 2A.

FIG. 3 illustrates an overview of an example conceptual diagram of a motion subassembly according to aspects of the present disclosure.

FIG. 4A illustrates a perspective view of a representative vehicle comprising a robotic arm according to aspects described herein, displaying the robotic arm in an example stowed configuration.

FIG. 4B illustrates a top view of the representative vehicle of FIG. 4A.

FIG. 4C illustrates a perspective view of the representative vehicle of FIG. 4A, displaying the robotic arm in an example deployed configuration.

FIG. 4D illustrates another perspective view of the representative vehicle according to FIG. 4C.

FIG. 5 illustrates an example of a suitable computing environment in which one or more aspects of the present application may be implemented.

### DETAILED DESCRIPTION

In the following detailed description, references are made to the accompanying drawings that form a part hereof, and in which are shown by way of illustrations specific embodiments or examples. These aspects may be combined, other aspects may be utilized, and structural changes may be made without departing from the present disclosure. Embodiments may be practiced as methods, systems or devices. Accordingly, embodiments may take the form of a hardware implementation, an entirely software implementation, or an implementation combining software and hardware aspects. The following detailed description is therefore not to be taken in a limiting sense, and the scope of the present disclosure is defined by the appended claims and their equivalents.

In examples, a robotic arm is used to interact with a surrounding environment, for example to manipulate a natural or a man-made feature and/or to collect data, among other examples. However, environmental conditions and mission considerations may introduce challenges in designing a suitable robotic arm, for example one that is within a payload mass and/or volume budget, having a certain number of degrees of freedom, and/or that can withstand low temperatures and/or large temperature fluctuations.

Accordingly, a robotic manipulator according to aspects of the present disclosure is comprised of a set of elements (e.g., a basal end, a configurable number of joints, and a distal end) that may be configured to yield a robotic arm having a specified number of degrees of freedom, while also tuning the mass and/or volume of the robotic arm. Additionally, a robotic arm according to aspects described herein may comprise components suited to challenging thermal environments and/or active thermal control, among other examples.

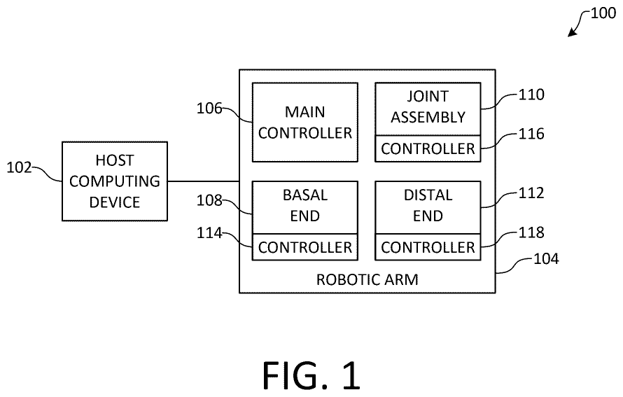

FIG. 1 illustrates an overview of an example conceptual diagram of a system 100 comprising a robotic arm 104 according to aspects of the present disclosure. A s illustrated, robotic arm 104 communicates with host computing device 102. In examples, robotic arm 104 and host computing device 102 communicate via a wired and/or wireless connection. For example, host computing device 102 provides movement instructions that are thus executed by robotic arm 104 accordingly. As another example, host computing device 102 provides a movement objective for robotic arm 104 (e.g., move distal end 112 to a position in space), such that main computer 106 of robotic arm 104 plans a path for constituent sections of robotic arm 104 to achieve the specified movement objective accordingly.

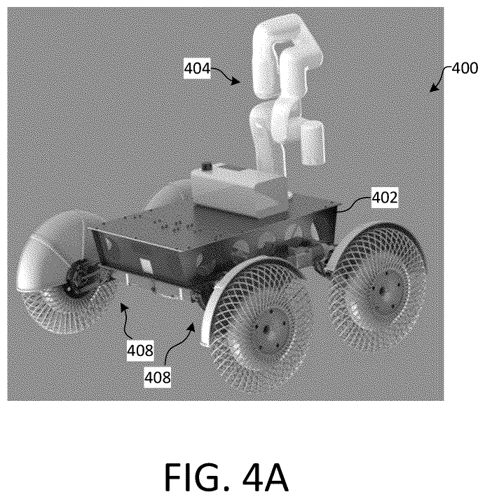

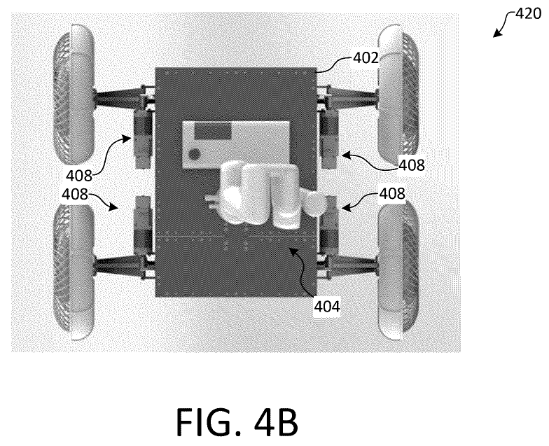

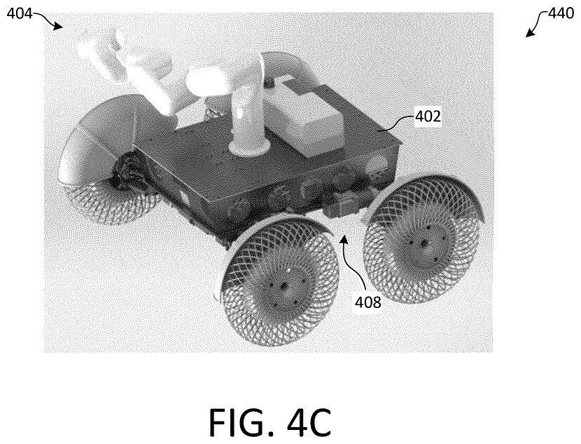

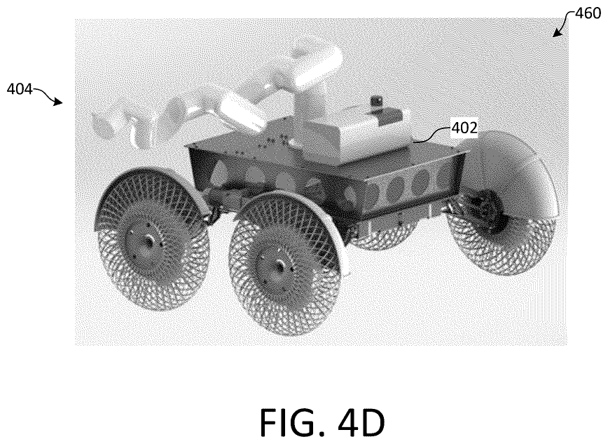

In examples, movement of robotic arm 104 is achieved via manual control (e.g., as operator input via host computing device 102) and/or via autonomous control (e.g., as a result of processing performed by host computing device 102), among other examples. In examples, host computing device 102 may form part of a rover (see FIGS. 4A-4D) to which robotic arm 104 is mounted or may be remote from robotic arm 104. It will therefore be appreciated that control of robotic arm 104 may be achieved by any of a variety of devices, for example according to processing performed local to and/or remote from robotic arm 104 according to aspects described herein.

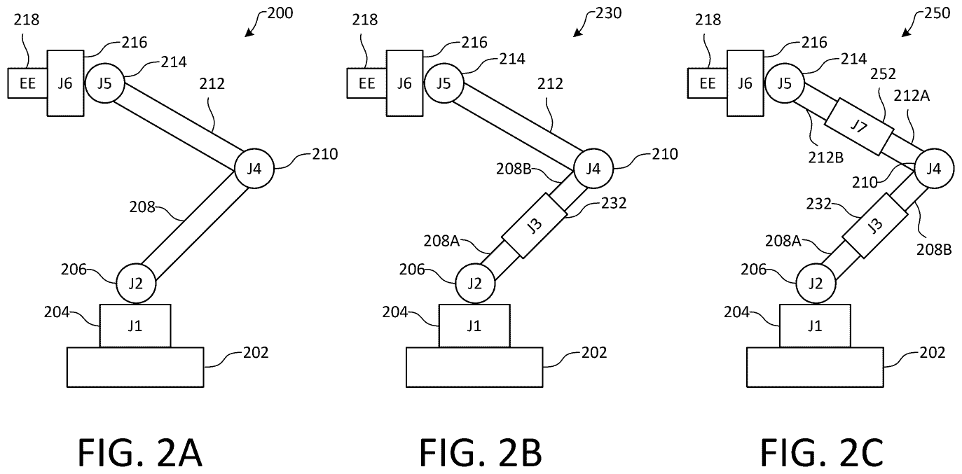

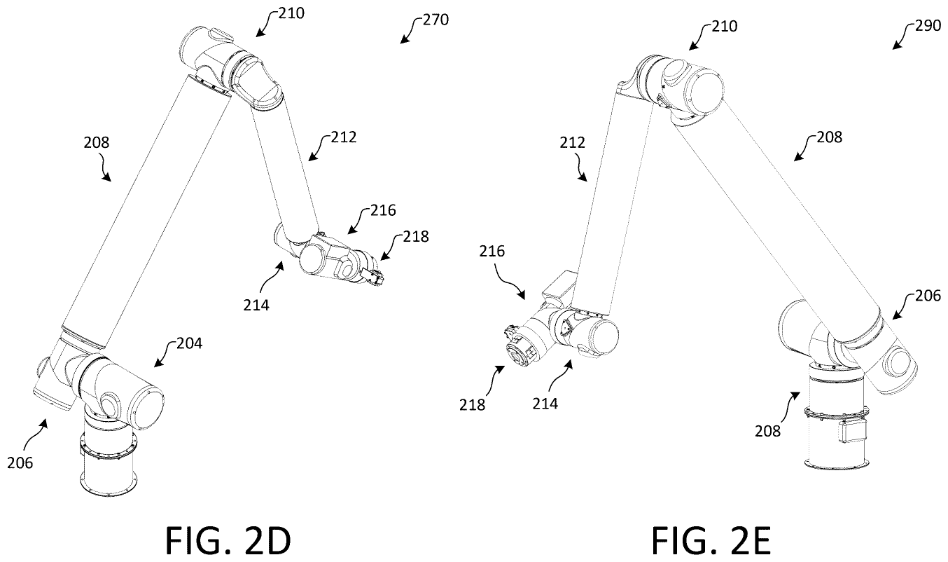

As illustrated, robotic arm 104 comprises main controller 106, basal end 108, joint assembly 110, and distal end 112. While system 100 is illustrated as including one joint assembly 110, it will be appreciated any number of joint assemblies may be used in other examples (e.g., as depicted in FIGS. 2A-2E, which are described in further detail below). As illustrated, basal end 108, joint assembly 110, and distal end 112 each comprise respective controller 114, 116, and 118.

Thus, in the depicted example, main controller 106 generates instructions that are provided to respective segments of robotic arm 104 (e.g., for processing by one or more of controllers 114, 116, and/or 118). Such aspects may simplify the design of robotic arm 104, where, for example, a common power bus is established for each segment (e.g., basal end 108, joint assembly 110, and distal end 112) and each segment comprises one or more motor controllers to drive a corresponding motor according to control by a respective controller 114, 116, or 118.

While main controller 106 provides instructions for further execution by controller 114, 116, and/or 118, it will be appreciated that main controller 106 may receive data from one or more such controllers which is used for further processing by main controller 106. For example, main controller 106 receives sensor data from each respective segment and/or from an end effector mounted at distal end 112 of robotic arm 104, among other examples. In examples, communication between main controller 106 and controllers 114, 116, and/or 118 is achieved via RS-485, a controller area network (CAN) bus, or Ethernet, among other examples. Additionally, multiple such communication technologies may be used, for example RS-485 for robotic arm control and Ethernet for high-speed communication with an end effector of robotic arm 104, among other examples.

By contrast, central control of robotic arm 104 (e.g., rather than each segment having an associated controller) may instead entail main controller 106 directly operating a set of motor controllers (rather than indirect control via controllers 114, 116, and 118) that each actuate a motor of a respective segment of robotic arm 104, which may introduce comparatively more complex wiring and power considerations (e.g., discrete, longer leads to each respective motor).

Even so, while the illustrated aspects provide an example of decentralized robotic arm control (e.g., with main controller 106 controlling controllers 114, 116, and 118, which each control corresponding motors in turn), it will be appreciated the disclosed aspects may similarly be applicable to a more centralized control system design in other examples. Additionally, while main controller 106 is illustrated separately from basal end 108, it will be appreciated that, in other examples, main controller 106 is included as part of basal end 108 (e.g., combined with or separate from controller 114).

Basal end 108 anchors robotic arm 104 (e.g., to a vehicle as in FIGS. 4A-4D or to a stationary surface). In examples, basal end 108 comprises one or more sensors, including, but not limited to, a torque sensor (e.g., a six-axis torque sensor), a current sensor, and/or an inertial measurement unit (IM U), among other examples. For instance, the torque sensor and/or IM U are used to evaluate environmental conditions and/or movement of robotic arm 104, including, but not limited to identifying a potential collision between robotic arm 104 and its environment and/or evaluating gravitational and/or other forces on robotic arm operation. As an example, such aspects may thus enable operation in scenarios with changing forces, as may occur if robotic arm 104 is in operation while a vehicle is maneuvering across terrain and/or in a plane other than that which is parallel to the ground, among other examples.

Robotic arm 104 further comprises joint assembly 110. As noted above, any number of such joint assemblies may be used in other examples. For example, joint assembly 110 is coupled to basal end 108 by a first arm member and is further coupled to distal end 112 by a second arm member. In another example comprising multiple such joint assemblies, the second arm member may instead couple joint assembly 110 to another joint assembly, which is in turn coupled to distal end 112 by a third arm member. Joint assembly 110 may couple two arm members such that respective longitudinal axes of the arm members are substantially parallel or substantially perpendicular, examples of which are discussed below with respect to FIGS. 2A-2E.

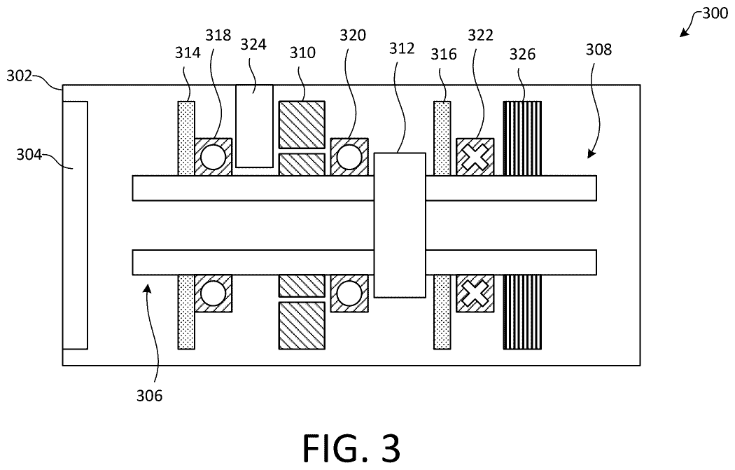

In examples, main controller 106 provides instructions to controller 116 of joint assembly 110, such that controller 116 provides control of joint assembly 110 accordingly. As detailed below with respect to FIG. 3, joint assembly 110 comprises a motion assembly having set of sensors and one or more motor controllers with which controller 116 achieves closed-loop control of joint assembly 110 accordingly.

As an example, main controller 106 provides instructions to each segment controller of robotic arm 104, such that each respective controller manages its respective segment accordingly. Main controller 106 receives sensor data and/or other feedback information from the segment controllers and my thus provide further instruction to one or more segment controllers accordingly, thereby establishing decentralized control of robotic arm 104 accordingly.

In examples, joint assembly 110 comprises one or more heaters to maintain temperature of one or more temperature-sensitive components therein, which may similarly be operated by controller 116 (e.g., based on one or more corresponding temperature sensors, for example to maintain a target temperature or to remain above a temperature threshold). In some examples, controller 116 operates an electric motor or joint assembly 110 so as to operate as a heater of joint assembly 110. Additional examples of such aspects are described by U.S. application Ser. No. 18/048,752, titled “Self-Heating Electric Motor Control,” the entire disclosure of which is hereby incorporated by reference.

Distal end 112 of robotic arm 104 is configured to receive an end effector, such that robotic arm 104 controls the position of the end effector within physical space to enable the end effector to interact with the surrounding environment accordingly. Example end effectors include, but are not limited to, a scoop, a sieve, a grabber/grasper, and/or an image capture device, among other examples. In some examples, distal end 112 enables the end effector to be removably coupled, such that the end effector of robotic arm 104 may be manually and/or automatically changed.

In examples, distal end 112 provides a data and/or power connector. Distal end 112 additionally, or alternatively, comprises a depth sensor (e.g., for calibration and/or collision avoidance), a single or stereo camera, a light detection and ranging (LIDAR) sensor, and/or a light source, among other examples.

While example aspects of basal end 108, joint assembly 110, and distal end 112 are described, it will be appreciated that, in other examples, basal end 108, joint assembly 110, and distal end 112 may each comprise one or more aspects from other such segments. For example, while a torque sensor is described with respect to basal end 108, it will be appreciated that, in other examples, joint assembly 110 and/or distal end 112 may comprise such a sensor.

FIGS. 2A-2C illustrate example robotic arm configurations 200, 230, and 250 that each have different associated degrees of freedom according to aspects described herein. With reference first to FIG. 2A, robotic arm configuration 200 comprises basal end 204, joints 206, 210, and 214, distal end 216, end effector 218, and arm members 208 and 212. As illustrated, basal end 204 is anchored to surface 202, which may be a stationary surface or may be a vehicle, among other examples.

Aspects of basal end 204, distal end 216, and joint assemblies 206, 210, and 214 are similar to those discussed above with respect to basal end 108, distal end 112, and joint assembly 110, and are therefore not necessarily redescribed in detail below. As illustrated, joint assemblies 206, 210, and 214 are coupled by arm members 208 and 212. Arm members 208 and 212 may each be comprised of a stiff but lightweight material, such as carbon fiber and/or aluminum. In the depicted example, robotic arm configuration 200 provides five degrees of freedom via basal end 204, joint assembly 206, joint assembly 210, joint assembly 214, and distal end 216.

Turning now to FIG. 2B, robotic arm configuration 230 is similar to FIG. 2A, but further comprises joint assembly 232. As noted above, joint assemblies need not be limited to providing perpendicular rotation (e.g., as illustrated by joint assemblies 206, 210, and 214) and may instead, for example, provide parallel rotation. Thus, joint assembly 232 provides rotation of arm member 208B about an axis that is substantially parallel to the longitudinal axis of arm member 208A. Thus, joint assembly 232 provides an additional degree of freedom, such that robotic arm configuration 232 establishes six degrees of freedom. While examples are depicted with respect to rotation that is substantially parallel and substantially perpendicular, it will be appreciated that other angles may be used in other examples.

With reference to FIG. 2C, joint assembly 252 is further provided. Similar to joint assembly 232, joint assembly 252 similarly provides substantially parallel rotation between arm members 212A and 212B. FIG. 2C thus depicts an example robotic arm configuration 250 that provides seven degrees of freedom.

It will be appreciated that segments 204, 206, 210, 214, 216, 232, and 252 (e.g., each providing a degree of freedom) may have movement subassemblies (e.g., FIG. 3) that each have similar or different specifications. For example, a movement subassembly closer to basal end 204 may have comparatively higher weight/torque requirements as a result of supporting more of the robotic arm assembly itself, whereas a movement subassembly closer to distal end 216 may have comparatively lower weight/torque requirements associated therewith.

FIGS. 2D and 2E illustrate perspective views 270 and 290 of an example robotic arm according to the robotic arm configuration 200 depicted in FIG. 2A. Thus, the depicted robotic arm provides five degrees of freedom, comprising basal end 204, joint assembly 206, arm member 208, joint assembly 210, arm member 212, joint assembly 216, distal end 216, and end effector 218. As illustrated, basal end 204 and distal end 216 each comprise a movement subassembly similar to the movement subassemblies of joint assemblies 206, 210, and 214. Additional examples of such movement subassemblies are discussed below with respect to FIG. 3.

FIG. 3 illustrates an overview of an example conceptual diagram of a motion subassembly 300 according to aspects of the present disclosure. As illustrated, motion subassembly 300 comprises housing 302, motor driver 304, motor 310, and gearbox 312. M otor controller 302 operates motor 310 (e.g., according to control by a controller, such as controller 114, 116, or 118 in FIG. 1) to drive input shaft 306. In the present example, input shaft 306 is supported by bearings 318 and 320, between which brake 324 is positioned. Two bearings 318 and 320 are provided to reduce a moment load that may result from the application of brake 324.

Input shaft is coupled to 312, which in turn drives output shaft 308. As illustrated, output shaft 308 is supported by bearing 322, which may be a radial or four-point bearing to provide improved handling of a moment load on the output side of movement subassembly 300 (e.g., to an arm member or to an end effector). While example bearings are described, it will be appreciated that any of a variety of other types of bearings may be used in other examples. In examples, brake 324 comprises a spring-loaded friction brake, which, as illustrated, introduces friction on input shaft 306. It will be appreciated that any of a variety of additional or alternative sources of braking force may be used and need not be introduced only at input shaft 306. Brake 324 is provided to improve the ability to retain a pose of the robotic arm while also offering reduced current draw (e.g., as motor 310 may be powered off or may be operated with reduced current when brake 324 is engaged). In examples, brake 324 is applied to input shaft 306 in the absence of power, thereby further providing reduced power consumption when the robotic arm is static.

Rotary encoders 314 and 316 are provided, with rotary encoder 314 being configured to measure rotation of input shaft 306 and rotary encoder 316 being configured to measure rotation of output shaft 316. Sensor data from rotary encoders 314 and 316 may be processed to establish control of motor 310 (e.g., by a respective segment controller and/or by a main controller such as main controller 106 in FIG. 1). It will be appreciated that any number of such encoders may be used (e.g., two, as in the present example, for fault tolerance and/or improved positional accuracy) or motor 310 may itself include such an encoder, among other examples.

As noted above, a robotic arm according to aspects of the present disclosure may be operated in a challenging environment. Accordingly, seal 326 is provided to reduce the potential for debris ingress. It will be appreciated that additional or alternative seals may be used in other examples. Additionally, or alternatively, gearbox 312 may be selected to provide improved operation in environments with low temperatures and/or high temperature fluctuations. For example, a strain wave gearbox may offer improved temperature change resistance as compared to other gearboxes, though it will be appreciated that, in other examples, other gearboxes (e.g., a planetary gearbox or a cycloidal gearbox) may be used.

Input shaft 306 and output shaft 308 are each illustrated as being hollow. Similarly, gearbox 312 may provide an aperture therethrough, such that wiring may pass through input shaft 306, gearbox 312, and output shaft 308, for example for connection to another arm segment and/or an end effector, among other examples. Additionally, or alternatively, movement subassembly 300 comprises a slipring (not pictured), thereby enabling power and/or data signals to be passed through movement subassembly 300. As noted above, a subsequent segment assembly may be coupled to movement subassembly 300 such that its longitudinal axis is substantially perpendicular to (e.g., joint assemblies 206, 210, and 214) or substantially parallel to (e.g., joint assemblies 232 and 252) output shaft 308, among other examples.

FIG. 4A illustrates a perspective view 400 of a representative vehicle 402, depicting a robotic arm 404 in an example “stowed” configuration. As illustrated, a frame of vehicle 402 supports robotic arm 404. With reference to FIG. 1, vehicle 402 may comprise a vehicle controller (not pictured), which may operate as a host computing device with respect to robotic arm 404 according to aspects described herein.

In examples, one or more actuators 408 (e.g., each of which are coupled to a ground-engaging member of vehicle 402) of vehicle 400 control a pose (e.g., heading, attitude, and/or elevation) of the vehicle body above the surface (e.g., to level surface 406 to which robotic arm 404 is coupled) are located along the sides of the vehicle in the depicted example. FIG. 4B illustrates a top view 420 of the representative vehicle 402 of FIG. 4A. As illustrated, robotic arm 404 is depicted in the example “stowed” configuration of FIG. 4A.

FIG. 4C illustrates a perspective view 440 of the representative vehicle 402 of FIG. 4A, displaying the robotic arm 404 in an example “deployed” configuration. FIG. 4D illustrates a different perspective view 460 of the representative vehicle 402, displaying a robotic arm 404 in a “deployed” configuration, reaching to the side of vehicle 402.

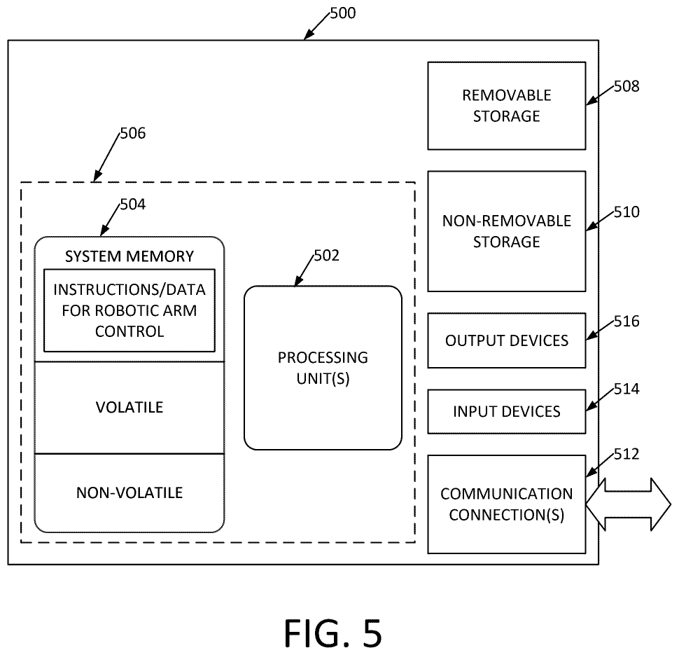

FIG. 5 illustrates an example of a suitable computing environment 500 in which one or more of the present embodiments may be implemented. For example, aspects of computing environment 500 may be used by a controller, such as a vehicle controller of a vehicle according to aspects described herein. This is only one example of a suitable computing environment and is not intended to suggest any limitation as to the scope of use or functionality. Other well-known computing systems, environments, and/or configurations that may be suitable for use include, but are not limited to, personal computers, server computers, hand-held or laptop devices, multiprocessor systems, microprocessor-based systems, programmable consumer electronics such as smart phones, network PCs, minicomputers, mainframe computers, distributed computing environments that include any of the above systems or devices, and the like.

In its most basic configuration, computing environment 500 typically may include at least one processing unit 502 and memory 504. Depending on the exact configuration and type of computing device, memory 504 (storing, among other things, A Pls, programs, etc. and/or other components or instructions to implement or perform the system and methods disclosed herein, etc.) may be volatile (such as RAM), non-volatile (such as ROM, flash memory, etc.), or some combination of the two. This most basic configuration is illustrated in FIG. 5 by dashed line 506. Further, environment 500 may also include storage devices (removable, 508, and/or non-removable, 510) including, but not limited to, magnetic or optical disks or tape. Similarly, environment 500 may also have input device(s) 514 such as a keyboard, mouse, pen, voice input, etc. and/or output device(s) 516 such as a display, speakers, printer, etc. Also included in the environment may be one or more communication connections, 512, such as LAN, WAN, point to point, etc.

Computing environment 500 may include at least some form of computer readable media. The computer readable media may be any available media that can be accessed by processing unit 502 or other devices comprising the computing environment. For example, the computer readable media may include computer storage media and communication media. The computer storage media may include volatile and nonvolatile, removable and non-removable media implemented in any method or technology for storage of information such as computer readable instructions, data structures, program modules or other data. The computer storage media may include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other non-transitory medium, which can be used to store the desired information. The computer storage media may not include communication media.

The communication media may embody computer readable instructions, data structures, program modules, or other data in a modulated data signal such as a carrier wave or other transport mechanism and includes any information delivery media. The term “modulated data signal” may mean a signal that has one or more of its characteristics set or changed in such a manner as to encode information in the signal. For example, the communication media may include a wired media such as a wired network or direct-wired connection, and wireless media such as acoustic, RF, infrared and other wireless media. Combinations of the any of the above should also be included within the scope of computer readable media.

The computing environment 500 may be a single computer operating in a networked environment using logical connections to one or more remote computers. The remote computer may be a personal computer, a server, a router, a network PC, a peer device or other common network node, and typically includes many or all of the elements described above as well as others not so mentioned. The logical connections may include any method supported by available communications media. Such networking environments are commonplace in offices, enterprise-wide computer networks, intranets, and the Internet.

The different aspects described herein may be employed using software, hardware, or a combination of software and hardware to implement and perform the systems and methods disclosed herein. Although specific devices have been recited throughout the disclosure as performing specific functions, one skilled in the art will appreciate that these devices are provided for illustrative purposes, and other devices may be employed to perform the functionality disclosed herein without departing from the scope of the disclosure.

As stated above, a number of program modules and data files may be stored in the system memory 504. While executing on the processing unit 502, program modules (e.g., applications, Input/Output (I/O) management, and other utilities) may perform processes including, but not limited to, one or more of the stages of the operational methods described herein.

Furthermore, examples of the invention may be practiced in an electrical circuit comprising discrete electronic elements, packaged or integrated electronic chips containing logic gates, a circuit utilizing a microprocessor, or on a single chip containing electronic elements or microprocessors. For example, examples of the invention may be practiced via a system-on-a-chip (SOC) where each or many of the components illustrated in FIG. 5 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality described herein may be operated via application-specific logic integrated with other components of the computing environment 500 on the single integrated circuit (chip). Examples of the present disclosure may also be practiced using other technologies capable of performing logical operations such as, for example, AND, OR, and NOT, including but not limited to mechanical, optical, fluidic, and quantum technologies. In addition, examples of the invention may be practiced within a general purpose computer or in any other circuits or systems.

Aspects of the present disclosure, for example, are described above with reference to block diagrams and/or operational illustrations of methods, systems, and computer program products according to aspects of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more aspects provided in this application are not intended to limit or restrict the scope of the disclosure as claimed in any way. The aspects, examples, and details provided in this application are considered sufficient to convey possession and enable others to make and use the best mode of claimed disclosure. The claimed disclosure should not be construed as being limited to any aspect, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

What is claimed is:

1. A robotic arm, comprising:
a basal end, comprising a first set of sensors and a first controller;
a joint assembly, comprising a second set of sensors and a second controller, wherein the joint assembly is coupled to a first arm member and the first arm member is coupled to the basal end;
a distal end, comprising a third set of sensors and a third controller, wherein the distal end is coupled to a second arm member and the second arm member is coupled to the joint assembly; and
a main controller communicably coupled to the first controller, the second controller, and the third controller.

2. The robotic arm of claim 1, wherein:
the joint assembly further comprises a motor controller and an electric motor; and
the second controller processes sensor data from the second set of sensors to generate a control signal for the motor controller to control the electric motor of the joint assembly.

3. The robotic arm of claim 2, wherein the control signal generated by the second controller is further based on an instruction received from the main controller.

4. The robotic arm of claim 1, wherein each of the basal end, the joint assembly, and the distal end comprise a respective movement subassembly, comprising:
a motor coupled to an input shaft of a gearbox;
an gearbox comprising the input shaft and an output shaft; and
a rotary encoder coupled to the input shaft or the output shaft.

5. The robotic arm of claim 4, wherein the rotary encoder is a first rotary encoder coupled to the input shaft and the respective movement subassembly further comprises a second rotary encoder coupled to the output shaft.

6. The robotic arm of claim 4, wherein the input shaft and the output shaft are hollow, and the gearbox further comprises an aperture configured to receive wiring of the robotic arm therethrough.

7. The robotic arm of claim 4, wherein each respective movement subassembly further comprises:
a first bearing and a second bearing each supporting the input shaft; and
a brake disposed between the first bearing and the second bearing configured to act on the input shaft when engaged.

8. The robotic arm of claim 7, wherein each respective movement subassembly further comprises a third bearing coupled to the output shaft of the gearbox.

9. The robotic arm of claim 8, further comprising a seal through which the output shaft of the respective movement subassembly extends.

10. The robotic arm of claim 4, wherein the gearbox is a strain wave gearbox.

11. The robotic arm of claim 1, wherein the joint assembly further comprises a heater and the second controller of the joint assembly is configured to selectively operate the heater based on a temperature sensor of the second set of sensors.

12. The robotic arm of claim 1, wherein:
the main controller is communicably coupled with the first controller, the second controller, and the third controller via a first bus; and
the robotic arm further comprises a second bus configured to electrically couple to an end effector.

13. The robotic arm of claim 1, wherein
the joint assembly is a first joint assembly;
the first arm member comprises a first arm member portion and a second arm member portion; and
a second joint assembly couples the first arm member portion and the second arm member portion, such that a longitudinal axis of the first arm member portion is substantially parallel to a longitudinal axis of the second arm member portion.

14. A vehicle, comprising:
a plurality of ground-engaging members;
a frame supported by the ground-engaging members; and
a robotic arm supported by the frame, the robotic arm comprising:
a basal end, comprising a first set of sensors and a first controller;
a joint assembly, comprising a second set of sensors and a second controller, wherein the joint assembly is coupled to a first arm member and the first arm member is coupled to the basal end;
a distal end, comprising a third set of sensors and a third controller, wherein the distal end is coupled to a second arm member and the second arm member is coupled to the joint assembly; and
a main controller communicably coupled to the first controller, the second controller, and the third controller.

15. The vehicle of claim 14, wherein each of the basal end, the joint assembly, and the distal end comprise a respective movement subassembly, comprising:
a motor coupled to an input shaft of a gearbox;
an gearbox comprising the input shaft and an output shaft; and
a rotary encoder coupled to the input shaft or the output shaft.

16. The vehicle of claim 15, wherein the rotary encoder is a first rotary encoder coupled to the input shaft and the respective movement subassembly further comprises a second rotary encoder coupled to the output shaft.

17. The vehicle of claim 15, wherein the input shaft and the output shaft are hollow, and the gearbox further comprises an aperture configured to receive wiring of the robotic arm therethrough.

18. The vehicle of claim 15, wherein each respective movement subassembly further comprises:
a first bearing and a second bearing each supporting the input shaft; and
a brake disposed between the first bearing and the second bearing configured to act on the input shaft when engaged.

19. The vehicle of claim 15, wherein the gearbox is a strain wave gearbox.

20. The vehicle of claim 14, further comprising a vehicle controller communicably coupled to the main controller of the robotic arm, wherein the main controller of the robotic arm is configured to receive an instruction from the vehicle controller and generate a control instruction for at least one of the first controller, the second controller, and the third controller.
